(19) United States
(12) Patent Application Publication
(10) Pub. No.: US 2026/0061624 A1
(43) Pub. Date: Mar. 5, 2026

(54) CONTROL DEVICE, CONTROL METHOD, STORAGE MEDIUM, AND HANDLING SYSTEM

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 19/280,182

(22) Filed: Jul. 25, 2025

(30) Foreign Application Priority Data
Aug. 30, 2024 (JP) 2024-149975

(51) Int. Cl. B25J 9/16

(52) U.S. Cl. CPC B25J 9/1697; B25J 9/1612

(57) ABSTRACT

In order to attain an object of achieving an accurate gripping operation without using a vision sensor, a control device adjusts a direction of a robot hand so that the robot hand directly faces a gripping target, by controlling a posture of a robot arm so that a grid pattern imaged by an imaging section and a predetermined grid pattern are similar.

This Nonprovisional application claims priority under 35 U.S.C. § 119 on Patent Application No. 2024-149975 filed in Japan on Aug. 30, 2024, the entire contents of which are hereby incorporated by reference.

### TECHNICAL FIELD

The present invention relates to a control device, a control method, and a control program each for controlling a robot arm. Further, the present invention relates to a handling system including a robot arm and a control device.

### BACKGROUND ART

Handling systems have been widely used which are configured to hand various articles with use of robot arms to which robot hands are mounted. The articles (hereinafter, also referred to as “workpiece”) to be handled range widely from mechanical components such as bolts to food such as hamburger patties.

In a case where a workpiece having a complicated shape or a soft workpiece is handled, an accurate gripping operation is needed. This is because an inaccurate gripping operation on a workpiece having a complicated shape highly likely results in failure of the gripping, and an inaccurate gripping operation on a soft workpiece highly likely results in damage to the workpiece.

In order to achieve an accurate gripping operation, a configuration of, during the gripping operation, repeatedly performing monitoring of a position and orientation of a robot hand with respect to a workpiece and correction of the position and orientation of the robot hand based on a result of the monitoring is often employed. The monitoring of the position and orientation of the robot hand with respect to the workpiece is typically performed with use of a plurality of vision sensors.

In order to achieve the accurate gripping operation, it is also important to accurately identify the shape of the workpiece. For example, Patent Literature 1 discloses a technology of identifying the shape of a workpiece by applying a phase shift method to an image including, as a subject, a workpiece to which a striped pattern is projected.

### CITATION LIST

### Patent Literature

### Patent Literature 1

Japanese Patent Application Publication Tokukai No. 2019-58993

### SUMMARY OF INVENTION

### Technical Problem

The handling system that, during the gripping operation, repeatedly performs monitoring of a position and orientation of a robot hand with respect to a workpiece and correction of the position and orientation of the robot hand based on a result of the monitoring raises problems as follows. First, the vision sensor is expensive. This makes it difficult to reduce the cost of such a handling system. Secondly, the process of analyzing an image obtained with use of the vision sensor to identify the position and orientation of the workpiece takes time. This makes it difficult to make the gripping operation faster with such a handling system. The technique disclosed in Patent Literature 1 is a technique for identifying a shape of a workpiece, and therefore does not directly contribute to solving these problems.

An aspect of the present invention has been made in light of the foregoing problem, and it is an object thereof to achieve an accurate gripping operation without using a vision sensor in a handling system.

### Solution to Problem

A control device in accordance with an aspect of the present invention is a control device that controls a posture of a robot arm to which a robot hand is mounted, the robot hand including a projection section that projects a grid pattern on a gripping target and an imaging section that images the grid pattern projected on the gripping target, the projection section being configured to project a predetermined grid pattern on a plane directly facing the robot hand, the control device performing a direction adjusting process of adjusting a direction of the robot hand so that the robot hand directly faces the gripping target, by controlling the posture of the robot arm so that the grid pattern imaged by the imaging section and the predetermined grid pattern are similar.

A control method in accordance with an aspect of the present invention is a control method for controlling a posture of a robot arm to which a robot hand is mounted, the robot hand including a projection section that projects a grid pattern on a gripping target and an imaging section that images the grid pattern projected on the gripping target, the projection section being configured to project a predetermined grid pattern on a plane directly facing the robot hand, the control method including a direction adjusting process of adjusting a direction of the robot hand so that the robot hand directly faces the gripping target, by controlling the posture of the robot arm so that the grid pattern imaged by the imaging section and the predetermined grid pattern are similar.

### Advantageous Effects of Invention

According to an aspect of the present invention, it is possible to achieve accurate gripping operation without using a vision sensor.

### BRIEF DESCRIPTION OF DRAWINGS

FIG. 1 is a side view illustrating a configuration of a handling system in accordance with an embodiment.

FIG. 2 is a side view illustrating a positional relationship between a workpiece and a robot hand in the handling system illustrated in the FIG. 1.

FIG. 3 is a view illustrating an image captured by an imaging section of the robot hand in the handling system illustrated in FIG. 1. The reference numeral 3001 of FIG. 3 indicates an image captured before a direction adjusting operation is performed, and the reference numeral 3002 of FIG. 3 indicates an image captured after the direction adjusting operation has been performed.

FIG. 4 is a view illustrating an image captured by an imaging section of the robot hand in the handling system illustrated in FIG. 1. The reference numeral 4001 of FIG. 4 indicates an image captured before a position adjusting operation is performed, and the reference numeral 4002 of FIG. 4 indicates an image captured after the position adjusting operation has been performed.

### DESCRIPTION OF EMBODIMENTS

### Configuration of Handling System

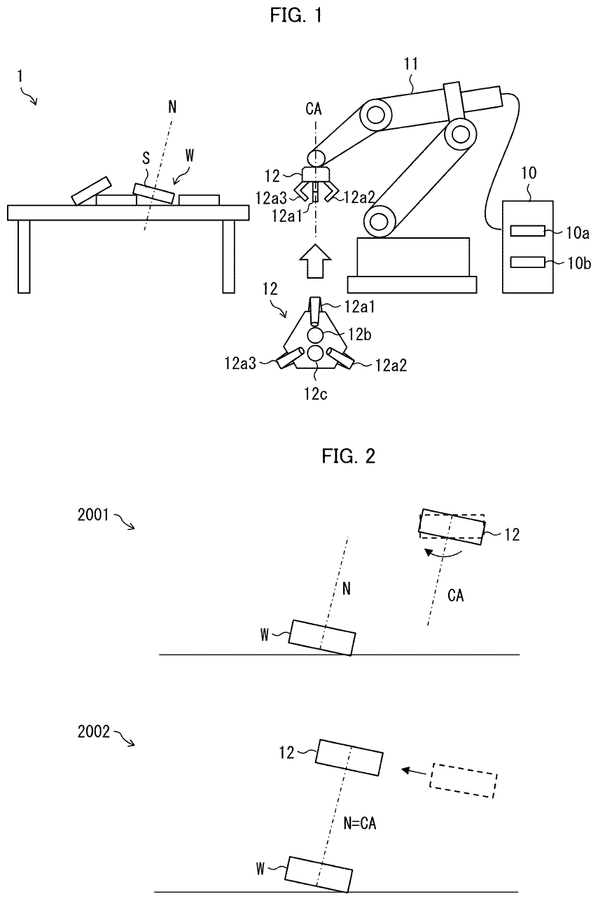

With reference to FIG. 1, the following description will discuss a configuration of a handling system 1 in accordance with an embodiment of the present invention. FIG. 1 is a side view illustrating a configuration of the handling system 1. In FIG. 1, a plan view illustrating a robot hand 12 included in the handling system 1 as seen from a finger side is also shown.

The handling system 1, which is a system for handling a workpiece W, includes a robot arm 11, the robot hand 12 mounted to the robot arm 11, and a control device 10 configured to control a posture of the robot arm 11. The workpiece W is not particularly limited, but has at least one surface. Hereinafter, this surface is referred to as “main surface S” of the workpiece W. A straight line that passes a representative point (e.g., center point) of this surface and is perpendicular to this surface is referred to as “main normal line N” of the workpiece W. The workpiece W, which is an object to be gripped by the robot hand 12, can be also expressed as “gripping target”.

The robot arm 11 is configured to change a posture thereof to set the position and direction of the robot hand 12. In the present embodiment, as the robot arm 11, a vertical articulated robot is used. In this case, changing the posture of the robot arm 11 is synonymous with changing joint angles of the joints.

The robot hand 12 is configured to change a posture thereof to grip the workpiece W. In the present embodiment, as the robot hand 12, a three-finger robot hand having fingers 12a1 to 12a3 is used. As one example, the first finger 12a1 is a fixed finger, whereas the second finger 12a2 and the third finger 12a3 are movable fingers. In this case, changing the posture of the robot hand 12 is synonymous with changing joint angles of the movable fingers 12a2 to 12a3.

The robot hand 12 further includes a projection section 12b and an imaging section 12c. The projection section 12b is configured to project a grid pattern and a frame line on the workpiece W, and is disposed on a surface on a finger side of a housing of the robot hand 12 so that an optical axis of light outputted form the projection section 12b is parallel to a center axis CA of the robot hand 12. The projection section 12b is composed of, for example, a laser light source and a diffractive optical element (DOE) disposed on an optical path of laser light outputted from the laser light source. The imaging section 12c is configured to image the workpiece W on which the grid pattern is projected, and is disposed on the surface on the finger side of the housing of the robot hand 12 so that an optical axis of light inputted to the imaging section 12c is parallel to the center axis CA of the robot hand 12. The imaging section 12c is composed of, for example, an image sensor and a lens group disposed on an optical path of light inputted to the image sensor.

The projection section 12b is configured to project a predetermined grid pattern to a plane directly facing the robot hand 12. Here, the expression “plane directly faces the robot hand 12” means that the center axis CA of the robot hand 12 is perpendicular to the plane, that is, the optical axes of the projection section 12b and the imaging section 12c are perpendicular to the plane.

In the present embodiment, the projection section 12b is configured to project a grid pattern in a square lattice on the plane directly facing the robot hand 12. It should be noted that the present invention is not limited to this. For example, the projection section 12b may be configured to project a grid pattern in a face-centered lattice on the plane directly facing the robot hand 12 or may be configured to project a grid pattern in a hexagonal lattice on the plane directly facing the robot hand 12.

Further, the projection section 12b is configured to project, on the plane directly facing the robot hand 12, a frame line approximating an outer edge of the workpiece W disposed on this plane.

In the present embodiment, the projection section 12b is configured to project, on the plane directly facing the robot hand 12, a first frame line (hereinafter, also referred to as “inner frame line”) approximating the outer edge of the workpiece W disposed on this plane from the inside and a second frame line (hereinafter, also referred to as “outer frame line”) approximating the outer edge of the workpiece W disposed on this plane from the outside. It should be noted that the present invention is not limited to this. For example, the projection section 12b may be configured to project only the inner frame line on the plane directly facing the robot hand 12 or may be configured to project only the outer frame line on the plane directly facing the robot hand 12.

The control device 10 is configured to achieve handling of the workpiece W by controlling the robot arm 11 and the robot hand 12. In the present embodiment, as the control device 10, a general-purpose computer including a memory 10a and a processor 10b is used. In this case, the processor 10b performs a control program stored in the memory 10a, so that the robot arm 11 and the robot hand 12 are controlled.

### Features of Handling System

With reference to FIG. 2, the following description will discuss features of the handling system 1. FIG. 2 is a side view illustrating a positional relationship between the workpiece W and the robot hand 12 in the handling system 1.

Features of the handling system 1 include performing a direction adjusting operation and a position adjusting operation before performing a gripping operation.

The direction adjusting operation refers to an operation of controlling a posture of the robot arm 11 by the control device 10 to adjust the direction of the robot hand 12 so that the robot hand 12 directly faces the workpiece W. The grid pattern that is projected by the projection section 12b and is imaged by the imaging section 12c is used for this direction adjusting operation, as described later. Performing the direction adjusting operation allows the center axis CA of the robot hand 12 to be parallel to the main normal line N of the workpiece W, as indicated by the reference numeral 2001 of FIG. 2.

The position adjusting operation refers to an operation of controlling the posture of the robot arm 11 by the control device 10 to adjust the position of the robot hand 12 so that the robot hand 12 directly faces the workpiece W. The frame line that is projected by the projection section 12b and is imaged by the imaging section 12c is used for this position adjusting operation, as described later. Performing the position adjusting operation after the direction adjusting operation has been performed allows the center axis CA of the robot hand 12 to coincide with the main normal line N of the workpiece W (to be parallel to and overlap the main normal line N of the workpiece W), as indicated by the reference numeral 2002 of FIG. 2.

With the handling system 1, a gripping operation of gripping the workpiece W is performed after the direction adjusting operation and the position adjusting operation have been performed. This makes it possible to start the gripping operation from a state where it is ensured that the direction and position of the robot hand 12 are a direction and position made when the robot hand 12 directly faces the workpiece W. This makes it possible to appropriately grip the workpiece W with use of the robot hand 12 without correcting a trajectory of the robot hand 12 while monitoring the direction and position of the robot hand 12 with respect to the workpiece W during the gripping operation. Even if the workpiece W is a soft article such as food (for example, a hamburger patty), the workpiece W can be gripped without being damaged or broken.

In a case where the trajectory of the robot hand 12 is corrected while monitoring the direction and position of the robot hand 12 with respect to the workpiece W during the gripping operation, it is necessary to repeatedly perform processing such as imaging, image analysis, and trajectory correction during the gripping operation. This may raise an issue of reduced speed of the gripping operation. Further, in this case, it is necessary to add, to the configuration, a vision sensor for imaging the workpiece W and the robot hand 12 during the gripping operation. This may raise an issue of an increased manufacturing cost and operating cost for the handling system 1. In contrast, with the handling system 1 in accordance with the present embodiment, it is unnecessary to correct the trajectory of the robot hand 12 while monitoring the direction and position of the robot hand 12 with respect to the workpiece W during the gripping operation, and thus it is possible to reduce the possibility of occurrence of these issues.

### Direction Adjusting Operation

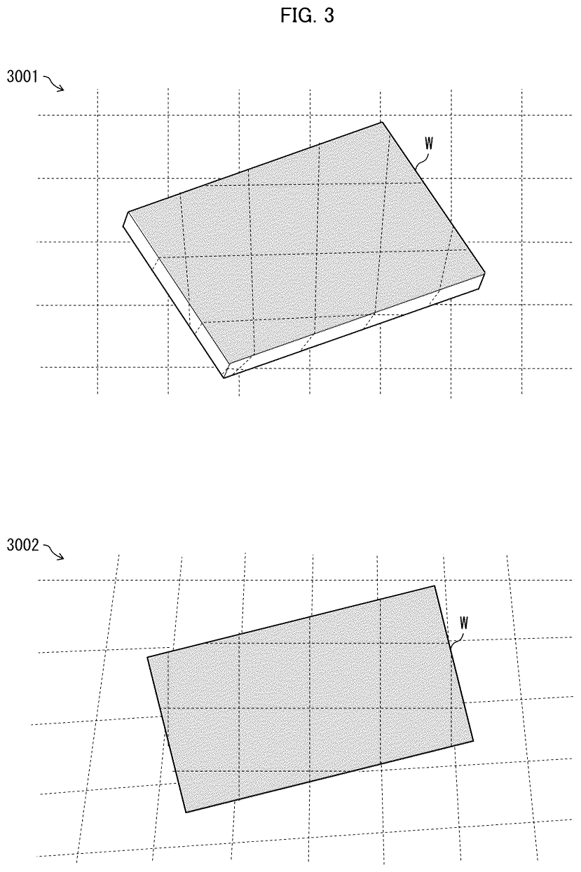

With reference to FIG. 3, the following description will discuss the direction adjusting operation performed with the handling system 1. In FIG. 3, the reference numeral 3001 indicates an image captured by the imaging section 12c before the direction adjusting operation is performed, and the reference numeral 3002 indicates an image captured by the imaging section 12c after the direction adjusting operation has been performed.

In the direction adjusting operation, the control device 10 performs a direction adjusting process with reference to the grid pattern included as a subject in the image captured by the imaging section 12c.

In a case where the direction of the robot hand 12 is not a direction made when the robot hand 12 directly faces the workpiece W, the grid pattern projected on the main surface S of the workpiece W is distorted and is not similar to a predetermined grid pattern, in the image captured by the imaging section 12c (see the reference numeral 3001 of FIG. 3). In contrast, in a case where the direction of the robot hand 12 is a direction made when the robot hand 12 directly faces the workpiece W, the grid pattern projected on the main surface S of the workpiece W is not distorted and is similar to a predetermined grid pattern, in the image captured by the imaging section 12c (see the reference numeral 3002 of FIG. 3).

The control device 10 performs the direction adjusting process with use of this nature. That is, a posture of the robot arm 11 is controlled so that in the image captured by the imaging section 12c, the grid pattern projected on the main surface S of the workpiece W is similar to the predetermined grid pattern. This makes it possible to adjust the direction of the robot hand 12 so that the robot hand 12 directly faces the workpiece W.

Note that the control device 10 can determine the direction of the robot hand 12 directly facing the workpiece W by, for example, “search”. As one example, the control device 10 repeatedly performs a process of obtaining an image captured by the imaging section 12c and a process of randomly changing the direction of the robot hand 12. The control device 10 then identifies, as the direction made when the robot hand 12 directly faces the workpiece W, the direction of the robot hand 12 at a time when an image in which the grid pattern projected on the main surface S of the workpiece W is similar to the predetermined grid pattern is captured.

Note that the control device 10 may control the posture of the robot arm 11 so that in the image captured by the imaging section 12c, the grid pattern projected on the main surface S of the workpiece W is similar to the predetermined grid pattern and a ratio of similarity between the grid pattern projected on the main surface S of the workpiece W and the predetermined grid pattern becomes a predetermined value. This makes it possible to set a distance from a plane including the main surface S of the workpiece W to the robot hand 12 to a predetermined distance.

### Position Adjusting Operation

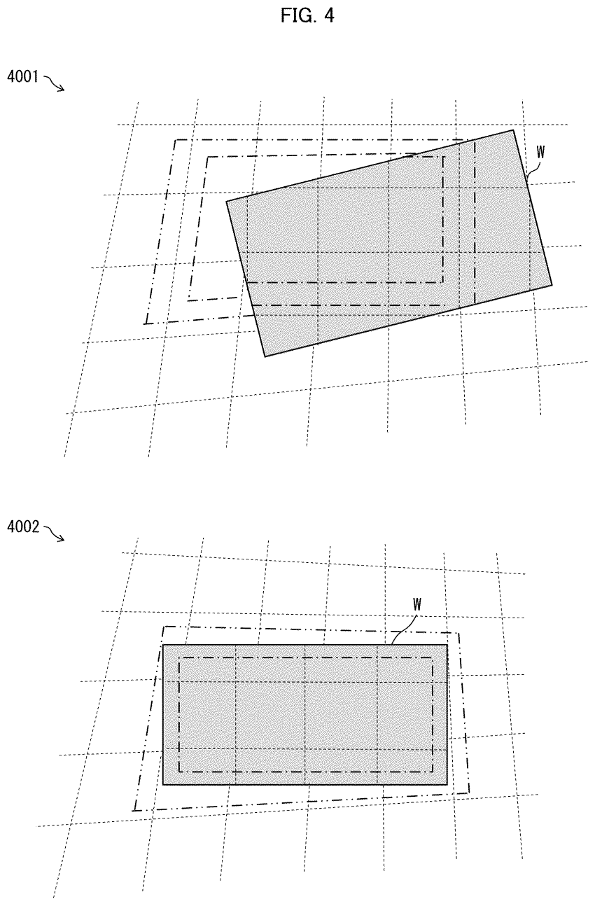

With reference to FIG. 4, the following description will discuss the position adjusting operation performed with the handling system 1. In FIG. 4, the reference numeral 4001 indicates an image captured by the imaging section 12c before the position adjusting operation is performed, and the reference numeral 4002 indicates an image captured by the imaging section 12c after the position adjusting operation has been performed.

In the position adjusting operation, the control device 10 performs a position adjusting process with reference to the inner frame line and the outer frame line included as subjects in the image captured by the imaging section 12c.

In a case where the position of the robot hand 12 is not a position made when the robot hand 12 directly faces the workpiece W, the outer edge of the workpiece W does not fall between the inner frame line and the outer frame line in the image captured by the imaging section 12c (see the reference numeral 4001 of FIG. 4). In contrast, in a case where the position of the robot hand 12 is a position made when the robot hand 12 directly faces the workpiece W, the outer edge of the workpiece W falls between the outer frame line and the inner frame line in the image captured by the imaging section 12c (see the reference numeral 4002 of FIG. 4). That is, the inner frame line is located inside the outer edge of the workpiece W, and the outer frame line is located outside the outer edge of the workpiece W.

The control device 10 performs the position adjusting process with use of this nature. That is, the posture of the robot arm 11 is controlled so that in the image captured by the imaging section 12c, the inner frame line is located inside the outer edge of the workpiece W and the outer frame line is located outside the outer edge of the workpiece W. This makes it possible to adjust the position of the robot hand 12 so that the robot hand 12 directly faces the workpiece W.

Note that the control device 10 can determine the position of the robot hand 12 directly facing the workpiece W by, for example, “search”. As one example, the control device 10 repeatedly performs a process of obtaining an image captured by the imaging section 12c and a process of randomly changing the position of the robot hand 12. Then, the control device 10 identifies, as the position made when the robot hand 12 directly faces the workpiece W, the position of the robot hand 12 at a time when an image in which the inner frame line is located inside the outer edge of the workpiece W and the outer frame line is located outside the outer edge of the workpiece W is captured.

### Software Implementation Example

Functions of the control device 10 can be realized by a control program for causing a computer to function as the control device 10. In this case, the control device 10 includes, as hardware for executing the control program, at least one processor and at least one memory. The functions of the control device 10 described in the above embodiments are realized by the control program stored in the at least one memory being executed by the at least one processor.

The control program may be stored in one or more non-transitory computer-readable storage media. This storage media may or may not be included in the control device 10. In the latter case, the control program may be supplied to the control device 10 via any transmission medium by wire or wireless.

Further, some or all of the functions of the control device 10 can be realized by a logic circuit. For example, the present disclosure encompasses, in its scope, an integrated circuit in which a logic circuit that achieves some or all of the functions of the control device 10 is formed.

Aspects of the present invention can also be expressed as follows:
A control device in accordance with Aspect 1 of the present invention is a control device that controls a posture of a robot arm to which a robot hand is mounted, the robot hand including a projection section that projects a grid pattern on a gripping target and an imaging section that images the grid pattern projected on the gripping target, the projection section being configured to project a predetermined grid pattern on a plane directly facing the robot hand, the control device performing a direction adjusting process of adjusting a direction of the robot hand so that the robot hand directly faces the gripping target, by controlling the posture of the robot arm so that the grid pattern imaged by the imaging section and the predetermined grid pattern are similar.
A control device according in accordance with Aspect 2 of the present invention is configured, in the control device in accordance with Aspect 1, such that in the direction adjusting process, the control device controls the posture of the robot arm so that the grid pattern imaged by the imaging section and the predetermined grid pattern are similar and a ratio of similarity between the grid pattern imaged by the imaging section and the predetermined grid pattern becomes a predetermined value.
A control device in accordance with Aspect 3 of the present invention is configured, in the control device in accordance with Aspect 1 or 2, such that the predetermined grid pattern is a grid pattern in a square lattice.
A control device in accordance with Aspect 4 of the present invention is configured, in the control device in accordance with any one of Aspects 1 to 3, such that the projection section is configured to project, on a plane directly facing the robot hand, a frame line approximating an outer edge of the gripping target disposed on the plane, after performing the direction adjusting process, the control device further performing a position adjusting process of adjusting a position of the robot hand so that the robot hand directly faces the gripping target, by controlling the posture of the robot arm so that the frame line imaged by the imaging section approximates the outer edge of the gripping target imaged by the imaging section.
A control device in accordance with Aspect 5 of the present invention is configured, in the control device in accordance with Aspect 4, such that the projection section is configured to project, on the plane directly facing the robot hand, a first frame line approximating the outer edge of the gripping target disposed on the plane from inside and a second frame line approximating the outer edge of the gripping target disposed on the plane from outside, in the position adjusting process, the control device controlling the posture of the robot arm so that the first frame line imaged by the imaging section is located inside the outer edge of the gripping target imaged by the imaging section and the second frame line imaged by the imaging section is located outside the outer edge of the gripping target imaged by the imaging section.
A control method in accordance with Aspect 6 of the present invention is a control method for controlling a posture of a robot arm to which a robot hand is mounted, the robot hand including a projection section that projects a grid pattern on a gripping target and an imaging section that images the grid pattern projected on the gripping target, the projection section being configured to project a predetermined grid pattern on a plane directly facing the robot hand, the control method including a direction adjusting process of adjusting a direction of the robot hand so that the robot hand directly faces the gripping target, by controlling the posture of the robot arm so that the grid pattern imaged by the imaging section and the predetermined grid pattern are similar.
A control program in accordance with Aspect 7 of the present invention is a control program for causing a computer to function as the control device in accordance with any one of Aspects 1 to 5, the control program causing the computer to perform the direction adjusting process.
A handling system in accordance with Aspect 8 of the present invention includes: the control device in accordance with any one of Aspects 1 to 5; and the robot hand.

### Additional Remarks

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

1. A control device that controls a posture of a robot arm to which a robot hand is mounted,
the robot hand comprising a projection section that projects a grid pattern on a gripping target and an imaging section that images the grid pattern projected on the gripping target,
the projection section being configured to project a predetermined grid pattern on a plane directly facing the robot hand,
the control device performing a direction adjusting process of adjusting a direction of the robot hand so that the robot hand directly faces the gripping target, by controlling the posture of the robot arm so that the grid pattern imaged by the imaging section and the predetermined grid pattern are similar.

2. The control device according to claim 1, wherein in the direction adjusting process, the control device controls the posture of the robot arm so that the grid pattern imaged by the imaging section and the predetermined grid pattern are similar and a ratio of similarity between the grid pattern imaged by the imaging section and the predetermined grid pattern becomes a predetermined value.

3. The control device according to claim 1, wherein the predetermined grid pattern is a grid pattern in a square lattice.

4. The control device according to claim 1, wherein the projection section is configured to project, on a plane directly facing the robot hand, a frame line approximating an outer edge of the gripping target disposed on the plane,
after performing the direction adjusting process, the control device further performing a position adjusting process of adjusting a position of the robot hand so that the robot hand directly faces the gripping target, by controlling the posture of the robot arm so that the frame line imaged by the imaging section approximates the outer edge of the gripping target imaged by the imaging section.

5. The control device according to claim 4, wherein the projection section is configured to project, on the plane directly facing the robot hand, a first frame line approximating the outer edge of the gripping target disposed on the plane from inside and a second frame line approximating the outer edge of the gripping target disposed on the plane from outside,
in the position adjusting process, the control device controlling the posture of the robot arm so that the first frame line imaged by the imaging section is located inside the outer edge of the gripping target imaged by the imaging section and the second frame line imaged by the imaging section is located outside the outer edge of the gripping target imaged by the imaging section.

6. A control method for controlling a posture of a robot arm to which a robot hand is mounted,
the robot hand comprising a projection section that projects a grid pattern on a gripping target and an imaging section that images the grid pattern projected on the gripping target,
the projection section being configured to project a predetermined grid pattern on a plane directly facing the robot hand,
the control method comprising a direction adjusting process of adjusting a direction of the robot hand so that the robot hand directly faces the gripping target, by controlling the posture of the robot arm so that the grid pattern imaged by the imaging section and the predetermined grid pattern are similar.

7. A computer-readable non-transitory storage medium storing a control program for causing a computer to function as the control device according to claim 1, the control program causing the computer to perform the direction adjusting process.

8. A handling system comprising:
the control device according to claim 1; and
the robot hand.
